(19) United States
(12) Patent Application Publication
(10) Pub. No.: US 2025/0235375 A1
(43) Pub. Date: Jul. 24, 2025

(54) Therapeutic Roller with Integrated Percussion

(71) Applicants: Darian Lee Wilson, Rancho Santa Fe, CA (US); Andrew Mark Cefai, Cambridge (GB)

(72) Inventors: Darian Lee Wilson, Rancho Santa Fe, CA (US); Andrew Mark Cefai, Cambridge (GB)

(21) Appl. No.: 19/171,760

(22) Filed: Apr. 7, 2025

Related U.S. Application Data
(63) Continuation of application No. PCT/US2023/034831, filed on Oct. 10, 2023.
(60) Provisional application No. 63/415,062, filed on Oct. 11, 2022.

(51) Int. Cl. A61H 23/00; A61H 15/00; A61H 23/02

(52) U.S. Cl. CPC A61H 23/006; A61H 15/0092; A61H 23/02; A61H 2015/0014; A61H 2201/0149; A61H 2201/0157; A61H 2201/1602; A61H 2201/1664

(57) ABSTRACT

A therapeutic roller includes a cavity defined in an interior of the therapeutic roller. A first percussion device is disposed within the cavity. The percussion device includes a first reciprocating percussion head. A first aperture is defined in an exterior of the therapeutic roller. The first percussion head extends through the first aperture so as to contact a bodily region of a user. The first percussion device delivers percussion massage therapy to the bodily region of the user in conjunction with therapeutic roller therapy.

### CROSS-REFERENCE TO RELATED APPLICATIONS

This patent application claims priority to, and incorporates by reference, the entire disclosure of U.S. Provisional Patent Application No. 63/415,062, filed on Oct. 11, 2022 and titled THERAPEUTIC ROLLER WITH INTEGRATED PERCUSSION.

### BACKGROUND

The following description relates generally to massage devices and more particularly, but not by way of limitation, to massage rollers having integrated percussion massage.

Ball-shaped or cylindrical massage roller devices often provide pressure-only massages that are non-targeted to specific muscles or connective tissues of the body, while percussive therapy massage devices are often difficult for a single user to position in such a way as to target specific muscles or connective tissues. Accordingly, there is a need for an improved massage device which incorporates single-user positioning abilities of a ball-shaped or cylindrical massage roller combined with specific muscle or connective tissue targeting capabilities of a percussive therapy massage device to provide more effective massage.

### DESCRIPTION OF DRAWINGS

FIG. 1 is a perspective view of an example of a therapeutic device;

FIG. 2. is a cross sectional view, taken along line A-A of the therapeutic device of FIG. 1;

FIG. 3 is a top view of the therapeutic device of FIG. 1;

FIG. 4 is a perspective view of an example therapeutic device utilizing an insert;

FIG. 5 is an end view of the example therapeutic device of FIG. 4;

FIG. 6 is an exploded perspective view of an example insert used in the example therapeutic device of FIG. 4;

FIG. 7 is an exploded view of the example therapeutic device of FIG. 4;

FIG. 8 is an illustration of an exemplary use of a therapeutic device;

FIG. 9 is an illustration of exemplary use of a therapeutic device with a chair.

FIG. 10 is a flow diagram illustrating a process for applying a therapeutic treatment to a bodily region.

### DETAILED DESCRIPTION

In some aspects of what is described here, a therapeutic roller includes one or more percussion therapy devices embedded therein. In various implementations, the therapeutic roller device may be, for example, a cylindrical-shaped or spherical-shaped foam or rubber roller. In other implementations, the therapeutic roller may be, for example, a prismatic shape having multiple faces. One or more percussion devices is coupled to the therapeutic roller. In various implementations, the one or more percussion devices may be disposed in a cavity formed in an interior of the therapeutic roller. In other implementations, the percussion devices may be coupled to a surface of the therapeutic roller. In various implementations, a plurality of percussion devices may be coupled to the therapeutic roller. In such implementations, the plurality of percussion devices may be arranged at a variety of angular orientations relative to an axis of the therapeutic roller. In other implementations, the plurality of percussion devices may be directed in a singular direction.

The therapeutic device described herein enables percussion therapy to be delivered to a bodily region simultaneously with roller massage. Roller massage, or self-myofascial release (SMR), is a technique used for the relaxation of stiffened muscles. Knots can sometimes form in muscles causing pain in various parts of the body. These muscle knots can be treated through therapeutic rollers. Therapeutic rollers apply pressure on these knots molding them into softer knots and gradually eliminating them. When pressure is applied via therapeutic rolling, it aids in reducing muscle tension and improves the process of recovery. Therapeutic rollers can be used to bring back the elasticity and vitality of a healthy muscle. Percussive therapy is a type of massage technique that applies rapid, repetitive pressure directly to specific points of the body. Applying percussive therapy to muscles can help increase blood flow, stimulate nerve receptors, and desensitize areas of pain. Combining therapeutic rolling with percussive therapy reaches deeper into muscles areas than therapeutic rollers alone, and allows for a more targeted single-user percussive massage experience based on each user's massage needs. Additionally, percussion devices need to be aligned correctly with the targeted area in order to be effective; however, the design of many percussion devices often does not allow a user to self-administer. This results in the users holding the percussion device at an ineffective angle. Use of a therapeutic device, such as the therapeutic device 100 or 400, allows a percussion device to be held in place at the most effective orientation.

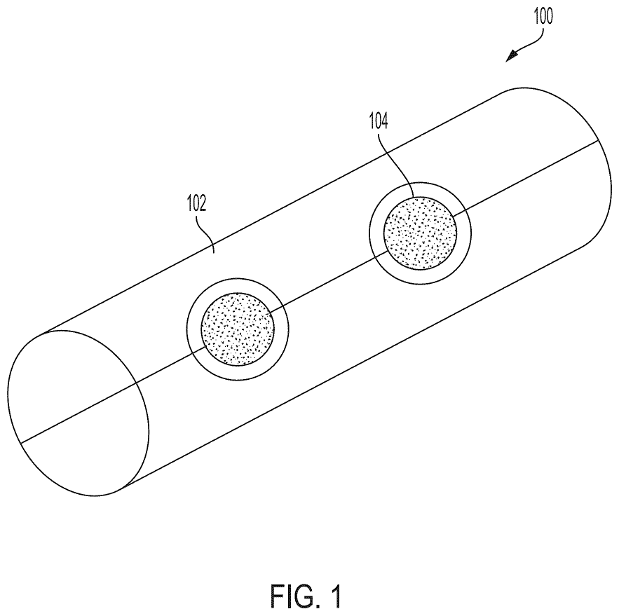

FIG. 1 is a perspective view of an example of a therapeutic device 100. The therapeutic device 100 includes a therapeutic roller 102 and a percussion device 104. The therapeutic roller 102 is illustrated herein by way of example as a cylindrical roller; however, in other implementations, the therapeutic roller 102 may be of a different shape such as, for example, spherical. In still other implementations, the therapeutic roller 102 may have a prismatic shape such as, for example, a rectangular prism, a triangular prism, a polygonal prism, an elliptical or oval prism, or another shape. By way of example, the therapeutic device 100 illustrated in FIG. 1 includes two percussion devices 104; however, in other implementations, the therapeutic device 100 may include a single percussion device 104, three percussion devices 104, or more percussion devices 104. In the example illustrated in FIG. 1, the percussion devices 104 are oriented in a single angular direction relative to an axis of the therapeutic roller 102. In other implementations, the percussion devices 104 may be oriented in multiple angular positions relative to the axis of the therapeutic roller 102 in order to provide percussion therapy in a plurality of angular orientations around the circumference of the therapeutic roller 102.

In the example illustrated in FIG. 1, the therapeutic roller 102 may be constructed, for example from an open-cell foam such as, for example, polyurethane foam or from a closed-cell foam such as, for example, polyethylene foam. In various embodiments, the therapeutic roller 102 may be constructed of, for example, expanded polyethylene foam, ethylene vinyl acetate foam, or polypropylene foam. In other implementations, other types of foam, rubber or other materials could be utilized. In some implementations, an exterior surface of the therapeutic roller 102 may include raised features protruding from an exterior surface of the therapeutic roller 102 such as, for example, lumps, nodules, ribs, ridges, or other protrusions. In other implementations, the exterior surface of the therapeutic roller may be smooth.

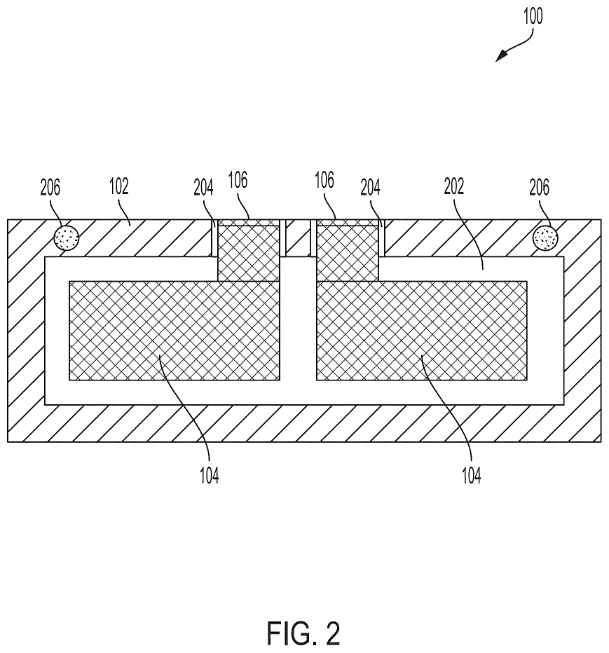

In the example illustrated in FIG. 1, the percussion device 104 may be any type of device capable of delivering a reciprocating force to a bodily region. In various implementations the percussion device 104 includes a reciprocating percussion head 106 (shown in FIG. 2) that is driven by, for example, a linear actuator or a reciprocating motor. In various implementations, the percussion device 104 may be actuated by, for example, a piezoelectric actuator, a solenoid actuator, a pneumatic actuator, a hydraulic actuator, or any other type of actuator. In some implementations, the percussion device 104 delivers reciprocating impulses of pressure to a bodily region of a user at a frequency in a wide range of approximately 5 Hz to approximately 50 Hz and an amplitude in a wide range of approximately 5 mm to approximately 30 mm. In various implementations, a length of the percussion head 106 may be adjustable relative to the exterior surface of the therapeutic roller 102. In such implementations, increasing a length of the percussion head 106 will result in a user feeling more intense percussion while decreasing the length of the percussion head 106 results in the user feeling less intense percussion. In some implementations, the percussion device 104 may deliver force to the user that is generally linear along a single axis of movement (e.g., reciprocating impulses of pressure delivered to a surface of the user's skin). In other embodiments, the percussion device 104 may deliver a force that acts along multiple axes. In some implementations, the percussion head 106 is oriented co-linearly with a body of the percussion device 104 (i.e., a “stick type” percussion device). In other implementations, the percussion head 106 is oriented at an angle relative to the body of the percussion device (i.e., a “gun type” percussion device). In still other implementations, the percussion device 104 may be any type of reciprocating percussion device.

In the example illustrated in FIG. 1, the percussion device 104 may be powered by, for example, a rechargeable battery. In such implementations, the rechargeable battery may be, for example, a nickel-cadmium (Ni-Cd) battery, a nickel metal hydride (Ni-MH) battery, a lithium-ion (Li-ion) battery, or a Lithium polymer (Li-Po) battery. In other implementations, the percussion device 104 may be powered, for example, by one or more replaceable batteries. In still other implementations, the percussion device 104 may be powered with alternating-current electricity.

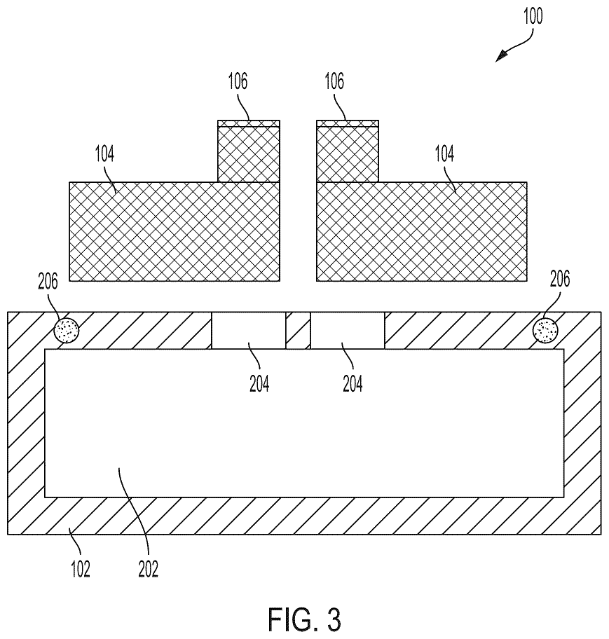

FIG. 2 is a cross-sectional view of an example of the therapeutic device 100. FIG. 3 is an exploded view of an example therapeutic device 100. A cavity 202 is formed in an interior of the therapeutic roller 102. The percussion device 104 is disposed within the cavity 202. An aperture 204 is formed in a surface of the therapeutic roller 102. The percussion device 102 is positioned within the cavity 202 such that the percussion head 106 extends through the aperture 204 to the surface of the therapeutic roller 102. In various implementations, the therapeutic roller may include multiple apertures arranged at various positions around the therapeutic roller.

In the examples illustrated in FIGS. 2 and 3, the therapeutic roller 102 opens in a clam-shell manner to provide access to the cavity 202. In other implementations, the therapeutic roller 102 may open in a variety of configurations to include openings located at either end of the device. In various implementations, the therapeutic roller 102 is secured in a closed position by fastener 206. In various implementations, the fastener 206 may be, for example, a snap, a hook-and-loop fastener, a latch, an adhesive, or other type of fastener to include bolts used to hold the device closed. In other implementations, percussion therapy devices will be inserted into either end of the therapeutic roller during the manufacturing process and no fastener is required.

During operation, the therapeutic roller 102 is utilized to provide a therapeutic treatment to a bodily region of a user. In some implementations, the therapeutic treatment may be, for example, a deep-tissue massage facilitated by pressure applied to the bodily region via the therapeutic roller 102. In addition to, or in combination with, the therapy provided by the therapeutic roller 102, the percussion device 104 may be utilized to deliver, for example, percussion massage to the bodily region. In some implementations, the percussion massage may be intermittent or continuous. In some implementations, the percussion massage may be of variable intensity.

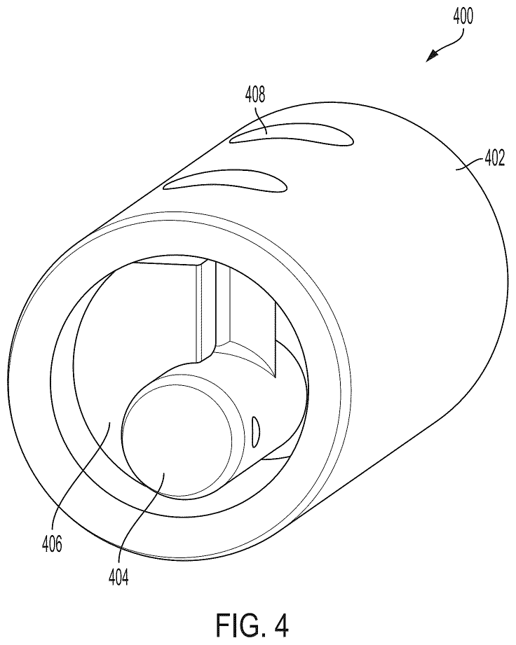

FIG. 4 is a perspective view of an example therapeutic device 400 using an insert 406. The therapeutic device 400 includes a therapeutic roller 402, a percussion device 404, and the insert 406. For clarity, the insert 406 is illustrated in FIG. 4 in partial cross-section. The therapeutic roller 402 is annular shaped and may be constructed, for example from an open-cell foam such as, for example, polyurethane foam or from a closed-cell foam such as, for example, polyethylene foam. In various embodiments, the therapeutic roller 102 may be constructed of, for example, expanded polyethylene foam, ethylene vinyl acetate foam, or polypropylene foam. In other implementations, other types of foam, rubber or other material could be utilized to provide a desired firmness, density, and cushioning. In some implementations, an exterior surface of the therapeutic roller 102 may include raised features protruding from an exterior surface of the therapeutic roller 102 such as, for example, lumps, nodules, ribs, ridges, or other protrusions. In other implementations, the exterior surface of the therapeutic roller may be smooth.

The percussion device 404 may be any type of device capable of delivering a reciprocating force to a bodily region. In various implementations the percussion device 404 includes a reciprocating percussion head 408 that is driven by, for example, a linear actuator or a reciprocating motor. In various implementations, the percussion device 404 may be actuated by, for example, a piezoelectric actuator, a solenoid actuator, a pneumatic actuator, a hydraulic actuator, or any other type of actuator. In some implementations, the percussion device 404 delivers reciprocating impulses of pressure to a bodily region of a user at a frequency in a range of approximately 5 Hz to approximately 50 Hz. In various implementations, the percussion therapy is applied at an amplitude sufficient to penetrate into the muscle tissue of the user. In various implementations, such an amplitude is approximately 5 mm to approximately 30 mm.

In various implementations, a length of the percussion head 408 may be adjustable relative to the exterior surface of the therapeutic roller 402. In such implementations, increasing a length of the percussion head 408 will result in a user feeling more intense percussion while decreasing the length of the percussion head 408 results in the user feeling less intense percussion. In some implementations, the percussion device 404 may deliver force to the user that is generally linear along a single axis of movement (e.g., reciprocating impulses of pressure delivered to a surface of the user's skin). In other embodiments, the percussion device 404 may deliver a force that acts along multiple axes. In some implementations, the percussion head 408 is oriented co-linearly with a body of the percussion device 404 (i.e., a “stick type” percussion device). In other implementations, the percussion head 408 is oriented at an angle relative to the body of the percussion device (i.e., a “gun type” percussion device). In still other implementations, the percussion device 404 may be any type of reciprocating percussion device.

The insert 406 may, in various implementations be constructed of a polymer such as, for example, acrylonitrile butadiene styrene (ABS), polylactic acid (PLA), polyvinyl alcohol (PVA), nylon, or another rigid polymer or other material. The insert 406 is generally cylindrical in shape and is sized to fit into an annular cavity within the therapeutic roller 402. The insert 406 has an axial channel 410 formed therein and a radial channel 412, which intersects the axial channel 410 in an approximately orthogonal fashion. The radial channel 412 and the axial channel 410 receive the percussion device 404 and secure the percussion device within the therapeutic roller 402.

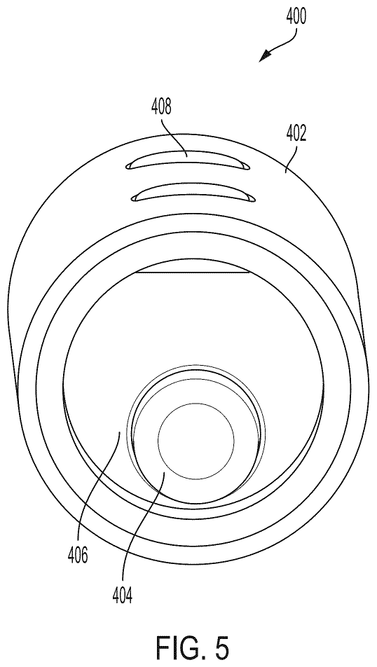

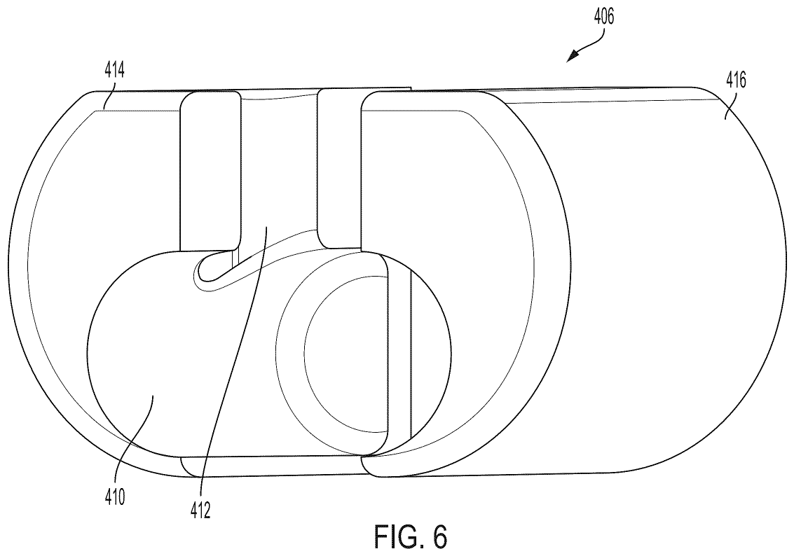

As illustrated in FIG. 6, the insert 406 includes a first portion 414 and a second portion 416. The first portion 414 and the second portion 416 may be assembled together to form the insert 406 having the axial channel 410 and the radial channel 412 formed therein. During assembly, the percussion device 404 is inserted into the portion of the axial channel 410 and the radial channel 412 formed in one of the first portion 414 or the second portion 416. The first portion 414 is then joined to the second portion 416 thereby enclosing the percussion device 404 within the insert 406. As shown in FIG. 5, the insert 406 is received into the annular cavity of the therapeutic roller 402. In various implementations, the insert 406 is sized to be coextensive with the annular cavity. In this manner, the annular cavity exerts inward pressure on the insert 406 thereby maintaining the first portion 414 and the second portion 416 in a mated arrangement with the percussion device 404 disposed therein.

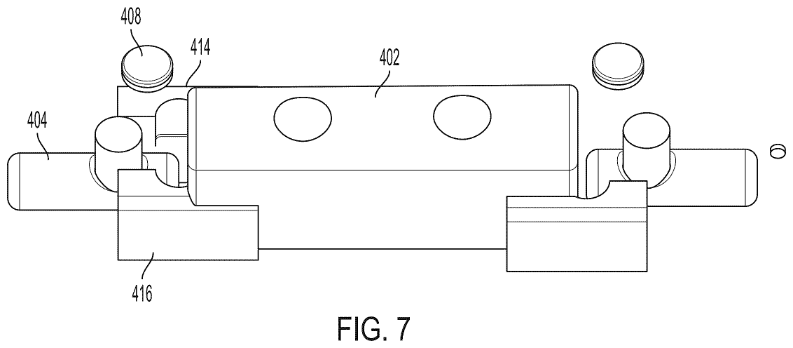

FIG. 7 is an exploded view of the example therapeutic device 400. The therapeutic device 400 is illustrated by way of example in FIG. 4 as including two percussion devices 404; however, in other implementations, the therapeutic device 400 may include a single percussion device. In other implementations, the therapeutic device 400 may include three or more percussion devices 404. Each percussion device 404 is received into the first portion 414 and the second portion 416 of the insert 406. The axial channel 410 and the radial channel 412 of each insert 406 hold the percussion device 404 in a desired orientation relative to the therapeutic roller 402. The insert 406, with the percussion device 404 disposed therein, is received into the annular cavity of the therapeutic roller 402. The percussion heads 408 are disposed on the percussion devices 404 such that the percussion heads 408 are flush with an outer surface of the therapeutic roller 402.

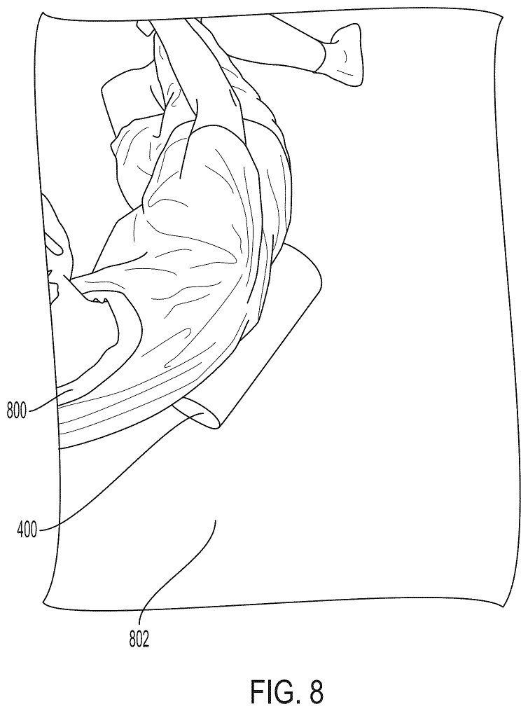

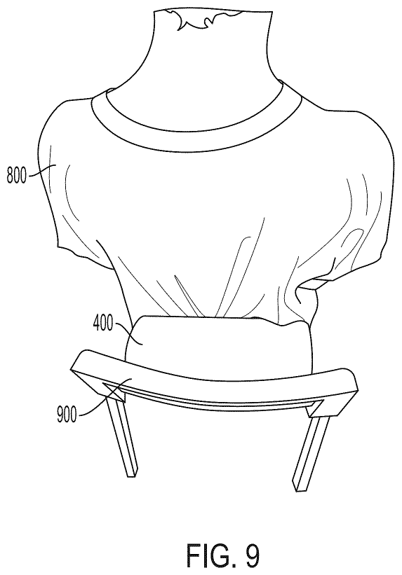

FIG. 8 is an illustration of an exemplary use of the therapeutic device 400. A user 800 has positioned the therapeutic device 400 between a bodily region and a solid surface 802. In the example shown in FIG. 8 the user 800 has positioned the therapeutic device 400 against a back region of the user 800. The solid object 802 is, for example, a floor. Use of the therapeutic device 400 in this manner allows the user 800 to reach areas of the lower back that may be difficult to access with a percussion device alone. For example, by securing the therapeutic device 400 between the floor and a back region, the user is able to maintain the percussion devices 404 in contact with the user's back region without use of his hands. As illustrated in FIG. 9, in other implementations, the user 800 may place the therapeutic device 400 against, for example, a back support of a chair 900 in order to secure the percussion devices 404 against the user's back. Such an arrangement facilitates maintaining targeted percussion therapy against the user's back while seated.

Combining percussion therapy with roller therapy into a single device offers a targeted and highly effective solution for addressing various musculoskeletal issues and promoting overall well-being. These two modalities, when used in tandem, synergize to enhance the benefits of each other, providing a comprehensive and tailored approach to muscle recovery and relaxation.

Percussion therapy, also known as percussive therapy, utilizes rapid, targeted percussive impacts to penetrate deep into muscle tissue. This technique helps to release muscle knots, improve blood circulation, and reduce muscle soreness. It's particularly effective at breaking down adhesions and scar tissue, making it an excellent choice for athletes and individuals recovering from injuries. Percussion therapy is typically applied at a wide range of frequencies from approximately 5 Hz to 50 Hz and a wide range of amplitude of approximately 5 mm to approximately 30 mm sufficient to penetrate into the muscle tissue of the user. In various implementations, such an amplitude is approximately 10 mm to approximately 20 mm. In contrast, vibration therapy is typically not targeted, more general in nature, does not extend as deep into the muscle tissue, and is applied at a generally higher frequency than percussion therapy. For example, vibration therapy is typically applied at a frequency greater than 50 Hz and at an amplitude of 3 mm to 5 mm. Vibration therapy devices typically utilize a flat surface to contact the skin of the user in order to facilitate the transfer of vibration to the user's skin. In contrast, percussion devices typically utilize a round or pointed head in order to facilitate delivery of percussion therapy to a specific targeted area. Additionally, in various implementations, percussion therapy may allow for interchangeability of percussion heads to allow use of percussion heads having a variety of shapes, materials, and densities. Finally, percussion devices need to be aligned correctly with the targeted area in order to be effective; however, the design of many percussion devices often does not allow a user to self-administer. This results in the users holding the percussion device at an ineffective angle. Use of a therapeutic device, such as the therapeutic device 100 or 400, allows a percussion device to be held in place at the most effective orientation.

Foam and rubber roller massage therapy involves rolling a dense therapeutic cylinder over various muscle groups. This technique provides a gentle yet effective form of self-myofascial release, reducing muscle tension and increasing flexibility. Therapeutic rolling is well-known for its ability to improve posture, alleviate muscle imbalances, and prevent injury.

When combined, these therapies offer a multitude of benefits. Firstly, a therapeutic device such as, for example, the therapeutic device 100 or 400 can be used to target specific trigger points and deep-seated muscle tension that may be difficult for a single user to reach with a percussion device alone. The therapeutic roller, in turn, can help to smoothen out any residual soreness or stiffness after the targeted percussive therapy, promoting a more comprehensive release of muscle tension.

Furthermore, the combination of these therapies can enhance the overall efficiency of the massage session. Percussive therapy can quickly loosen tight muscles, making it easier for the therapeutic roller to be effective. This synergy results in a faster and more effective recovery process.

Overall, the therapeutic device 100 or 400 offers a well-rounded solution for individuals seeking relief from muscle pain, tension, and fatigue. It caters to both acute and chronic issues.

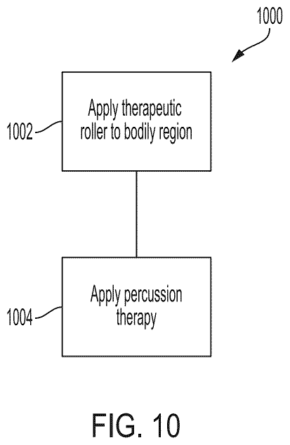

FIG. 10 illustrates an example process 1000 for applying a therapeutic treatment to a bodily region of a user. The example process 1000 may include additional or different operations, and the operations may be performed in the order shown or in another order. In some cases, operations can be combined, performed in another order, performed in parallel, iterated or otherwise repeated, or performed in another manner.

At 1002, a therapeutic roller is used to apply a therapeutic treatment to a bodily region of a user. In various implementations, the therapeutic roller may be the therapeutic roller 102, the therapeutic roller 402, or another therapeutic roller. The bodily region may be, for example, a user's back, a user's neck, a user's hip region, a user's leg region, a user's foot, or another bodily region.

At 1004, targeted percussion massage therapy is applied to the bodily region of the user via a percussion device that is embedded in the therapeutic roller. In various implementations, the percussion device may be the percussion device 104, the percussion device 404, or another percussion device.

In various implementations, the example process 1000 may also include securing the therapeutic roller against the bodily region of the user. In some implementations, the therapeutic roller may be pressed against the bodily region by a solid object such as, for example, a floor, or a chair back. Such an arrangement holds the percussion device in contact with, and in the proper orientation relative to, the bodily region of the user. In various implementations, the percussion therapy is applied at a frequency of approximately 5 Hz to approximately 50 Hz and at an amplitude sufficient to penetrate into the muscle tissue of the user. In various implementations, such an amplitude is approximately 5 mm to approximately 30 mm.

While this specification contains many details, these should not be understood as limitations on the scope of what may be claimed, but rather as descriptions of features specific to particular examples. Certain features that are described in this specification or shown in the drawings in the context of separate implementations can also be combined. Conversely, various features that are described or shown in the context of a single implementation can also be implemented in multiple embodiments separately or in any suitable subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single product or packaged into multiple products.

A number of embodiments have been described. Nevertheless, it will be understood that various modifications can be made. Accordingly, other embodiments are within the scope of the following claims.

1. A system comprising:
a cylindrical therapeutic roller;
a cavity defined in an interior of the cylindrical therapeutic roller;
a first percussion device disposed within the cavity, the percussion device comprising a first reciprocating percussion head oriented in a radial direction relative to the cylindrical therapeutic roller;
an insert that receives the first percussion device, the insert being received into the cavity defined in the interior of the cylindrical therapeutic roller;
a first aperture defined in a radial surface of the cylindrical therapeutic roller, the first reciprocating percussion head extending through the first aperture so as to contact a bodily region of a user; and
wherein the first percussion device delivers targeted percussion massage therapy to the bodily region of the user in conjunction with therapeutic roller therapy.

2. The system of claim 1, wherein the percussion device comprises a body and a percussion head.

3. The system of claim 2, wherein the percussion head is oriented co-linearly with the body.

4. The system of claim 2, wherein the percussion head is oriented perpendicular to the body.

5. The system of claim 1 comprising:
a second percussion device disposed within the cavity, the second percussion device comprising a second reciprocating percussion head oriented in the radial direction relative to the cylindrical therapeutic roller; and
a second aperture defined in the radial surface of the cylindrical therapeutic roller, the second reciprocating percussion head extending through the second aperture so as to contact a bodily region of a user.

6. The system of claim 5, wherein the first aperture and the second aperture are aligned on the radial surface of the cylindrical therapeutic roller.

7. The system of claim 5, wherein the first aperture and the second aperture are angularly displaced from each other about a circumference of the cylindrical therapeutic roller.

8. The system of claim 1, wherein the cylindrical therapeutic roller holds the percussion head in contact with a bodily region of a user.

9. The system of claim 1, wherein a height of the percussion head is adjustable thereby facilitating modulation of an intensity of the targeted percussion therapy.

10. The system of claim 1, wherein the targeted percussion therapy is delivered at a frequency in the range of approximately 5 Hz to approximately 50 Hz.

11. The system of claim 1, wherein the targeted percussion therapy is delivered at an amplitude in the range of approximately 5 mm to approximately 30 mm.

12. The system of claim 1, wherein the insert comprises:
an axial channel defined in an interior of the insert;
a radial channel defined in the interior of the insert, the radial channel intersecting the axial channel; and
wherein the axial channel and the radial channel receive the first percussion device.

13. A method comprising:
utilizing a cylindrical therapeutic roller to apply a therapeutic treatment to a bodily region of a user; and
applying a percussion massage therapy to the bodily region of the user, the percussion massage therapy being provided via a percussion device embedded in the cylindrical therapeutic roller through a radial surface of the cylindrical therapeutic roller, the percussion device being received into an insert, the insert being received into a cavity defined in an interior of the cylindrical therapeutic roller.

14. The method of claim 13, comprising adjusting an intensity of the percussion massage delivered by the percussion device.

15. The method of claim 14, wherein the adjusting comprises adjusting a length of a percussion head of the percussion device relative to the radial surface of the cylindrical therapeutic roller.

16. The method of claim 13, wherein the percussion massage is delivered continuously.

17. The method of claim 13, wherein the percussion massage is delivered intermittently.

18. The method of claim 13, wherein the percussion therapy is delivered at a frequency in the range of approximately 5 Hz to approximately 50 Hz.

19. The method of claim 13, wherein the percussion therapy is delivered an amplitude in the range of approximately 5 mm to approximately 30 mm.

20. The method of claim 13, comprising positioning the cylindrical therapeutic roller between the bodily region and a solid object so that the percussion device remains positioned against the bodily region.

21. The method of claim 20, wherein the solid object is a chair.

22. The method of claim 20, wherein the solid object is a floor.

23. The method of claim 13, comprising receiving the percussion device into an axial channel and a radial channel formed in the insert.
